(19) United States
(12) Patent Application Publication
(10) Pub. No.: US 2015/0342232 A1
(43) Pub. Date: Dec. 3, 2015

(54) HERBAL EXTRACT COMPOSITION

(71) Applicant: SUNTORY HOLDINGS LIMITED, Osaka-shi, Osaka (JP)

(72) Inventor: Akira YOSHIHIRO, Kanagawa (JP)

(21) Appl. No.: 14/655,063

(22) PCT Filed: Nov. 27, 2013
(86) PCT No.: PCT/JP2013/081844

§ 371 Date: Jun. 24, 2015

(30) Foreign Application Priority Data
Dec. 25, 2012 (JP) 2012-281605

(51) Int. Cl. A23L 1/222; A23L 2/60; A23L 1/221

(52) U.S. Cl. CPC A23L 1/2225; A23L 1/2215; A23L 2/60; A23V 2002/00

(57) ABSTRACT

The object of this invention is to provide a herbal extract composition having a refreshing sweetness on its own and a production method thereof. This invention provides a liquid composition containing a naringin at 60 mg/L or higher and hesperidin at 240 mg/L or higher, and that is obtained by immersing herbs selected from petals, buds and leaves of trees in an ethanol solution.

### TECHNICAL FIELD

The present invention relates to a herbal extract composition extracted using alcohol, and a production method thereof. The present invention also relates to a use of the herbal extract composition as a sweetener.

### BACKGROUND ART

Packaged beverages that are traditionally known include green tea, black tea, blended tea and the like, but components contained in the beverages, such as catechin, or caffeine make the beverages difficult to drink, so efforts are made to improve the drinkability of the beverages (Citation 1).

Meanwhile, near-water drinks composed of natural mineral water comprising fruit juice and the like are known, and it is recognized that an addition of herbal extracts is expected to provide aromatherapeutic effects (Citation 2).

### CITATION LIST

### Patent Documents

Patent Document 1: JP Publication No. 2011-10641

Patent Document 2: International Publication WO 2003/017788

### SUMMARY OF INVENTION

### Technical Problem

Conventional near-water drinks containing herbal extracts had a poor balance between the sweetness of a natural sweetener or a sweetener with high sweetness and the aroma of the herbal extract, and the flavor of the beverages needed improvement. Concerning this point, Citation 2 discloses that the balance of the herbal extract and the sweetener has been improved by using Palatinose™ as the sweetener, but Palatinose™ is costly, and it is unrealistic to replace all sweeteners to be used with Palatinose™ in view of costs and other problems.

In view of the above circumstances, the object of the present invention is to provide a herbal extract composition having a refreshing sweetness on its own. Another problem to be solved by the present invention is to provide an efficient production method of a herbal extract composition having a refreshing aroma.

### Solution to Problem

The present inventors repeated extensive research to solve the above problems and found that a herbal extract solution having sweetness on its own can be efficiently obtained by performing extraction on specific herbs at a specific alcohol concentration, and completed the present invention.

In other words, the present invention relates to the following without being limited thereby.
(1) A method for producing a liquid composition containing naringin at 60 mg/L or higher and hesperidin at 240 mg/L or higher, comprising

immersing herbs selected from petals, buds and leaves of a tree in an ethanol solution of 30 to 90 v/v % to obtain an immersion liquid containing naringin at 60 mg/L or higher and hesperidin at 240 mg/L or higher.
(2) The method according to (1), wherein the herbs are petals of a citrus tree.
(3) The method according to (1), wherein the herbs are petals of orange flower or elderflower.
(4) The method according to any of (1) to (3), wherein immersion is performed by using an ethanol solution containing saccharides and having a brix value in a range of 5 to 40.
(5) A liquid composition containing naringin at 60 mg/L or higher and hesperidin at 240 mg/L or higher, and obtained by immersing herbs selected from petals, buds and leaves of a tree in an ethanol solution.
(6) The liquid composition according to (5) that is used to add sweetness.
(7) A flavor containing the liquid composition according to (5).
(8) A food and drink containing the liquid composition according to (5).
(9) A method for adding sweetness to foods and drinks comprising adding the liquid composition according to (5).

### Advantageous Effects of Invention

A herbal extract composition having a refreshing sweetness can be efficiently produced according to the present invention. The herbal extract composition of the present invention not only has a refreshing sweetness on its own but it also has a refreshing herbal aroma, and the composition is quite useful as a raw material for beverages. The herbal extract composition of the present invention has a good sweetness and aroma, so it can be added to beverages and other foods as a flavor, such as a sweetener.

### DESCRIPTION OF EMBODIMENTS

The present invention relates to a herbal extract composition extracted by using alcohol (ethanol), and the composition of the present invention contains naringin at 60 mg/L or higher and hesperidin at 240 mg/L or higher.

Herbs in the present invention include not only plants useful as medical herbs or spices, but also petals, buds and leaves of plants, which are generally not called herbs as a whole. Particularly preferable herbs to be used to obtain the composition of the present invention are petals, buds and leaves of trees, particularly, the petals, buds, and leaves of citrus trees, and among those, the petals of citrus trees are most preferable. Examples of citrus trees that may be used include orange, mandarin, Citrus natsudaidai, Citrus unshiu, Citrus aurantium, lemon, lime, grapefruits, Citrus junos, Citrus sphaerocarpa, Citrus sudachi, Fortunella, Citrus poonensis, Citrus reticulata, tangerine, clementine, Citrus depressa, sweetie, bergamot. Examples of trees other than citrus trees that may be used include elderflower, ylang ylang (Cananga odorata), cherry, Japanese apricot, and peach. Considering preferable petals for obtaining the composition of the present invention, petals of orange flower or elderflower as particularly preferable. In addition, a single type or a combination of two or more types of herbs may be used for producing herbal extracts in the present invention. Note that “orange flower” used in the present invention includes both the bitter orange flower and sweet orange (i.e. orange) flower.

The production method of the above herbal extracts is not particularly limited, but extraction is possible by immersing herbs in a beverage alcohol solution (ethanol solution) and leaving it still. Any beverage alcohol can be used as long it is drinkable, and the preferable alcohol is ethanol. Raw material ethanols may be preferably used as ethanol, and distilled alcohol such vodka, shochu, spirits may be used. The alcohol concentration of an alcohol solution used in the immersion of herbs is preferably 30 to 90 v/v %, more preferably 35-85 v/v %, and even more preferably 45-65 v/v %. From the viewpoint of the balance of the aroma of the extract solution, an alcohol concentration of about 50% allows a herbal extract with a refreshing sweetness and aroma to be efficiently extracted, so this alcohol concentration is the most preferable.

The immersion (extraction) period is not particularly limited, but a period of 3 days or longer is preferable, a period of 5 days or longer is more preferable, and a period of about 1 week (7 days) or longer is even more preferable. The immersion time can be shortened by raising the immersion temperature. The immersion temperature is not particularly limited either, but a temperature of 5 to 70° C. is preferable, a temperature of 10 to 60° C. is more preferable, and a temperature of 15 to 40° C. is even more preferable in view of the extraction efficiency. In addition, the immersion period may be controlled by the amount of naringin or hesperidin contained in the extract solution, as explained hereinafter.

Further, when extracting components from herbs using alcohol, the brix value of the immersion liquid can be raised in advance by adding saccharides to the immersion liquid to improve the extraction efficiency, and to reduce the immersion period. Saccharides to be added to the alcohol solution, which is an immersion liquid, may be appropriately selected from disaccharides such as sucrose, and monosaccharides such as fructose or glucose, or these saccharides can be combined for use. When adding saccharides, they should preferably be added in an amount that imparts a brix value of 5 to 40 to the alcohol solution. Above all, sucrose should preferably added in an amount that imparts a brix value of 10 or higher to the alcohol solution, more preferably a brix value of 15 or higher, and most preferably in an amount that imparts a brix value of 20 to 30 to the alcohol solution. The brix value can be measured by a known method in the present invention, and it can be measured, for example, by using a general brix scale (saccharimeter) that uses an index of refraction.

In the present invention, it is possible to judge whether active components were sufficiently extracted from herbs by quantifying naringin or hesperidin contained in the obtained immersion liquid. Specifically speaking, for example, extraction may be judged as complete when the naringin content in the immersion liquid is 60 mg/L or higher and the hesperidin content is 240 mg/L or higher, and more preferably, extraction may be judged as complete when the naringin content is 70 mg/L or higher and the hesperidin content is 400 mg/L or higher. The upper limit of the concentration of naringin or hesperidin is not particularly limited, but in a preferable embodiment, for example, naringin concentration may be 3000 mg/L or lower, more preferably 2000 mg/L or lower. Also, the hesperidin concentration may be, for example, preferably 2000 mg/L or lower, more preferably 1500 mg/L or lower, and even more preferably 1000 mg/L or lower.

The amount ratio of naringin and hesperidin is also not particularly limited, but in a preferable embodiment, the hesperidin content/naringin content is preferably 2 or higher, more preferably 3 or higher, and even more preferably 4 or higher.

Hesperidin is a flavonoid that is contained richly in citrus; it is a type of polyphenol; and it is a substance allegedly having an antioxidant effect. Naringin is a flavonoid that is contained richly in citrus, such as grapefruits; and it allegedly induces a refreshing sensation or bitterness.

Terpenes or esters that provide refreshing aroma leach out in a preferable embodiment of the herb immersion liquid obtained by the present invention, and it is possible to obtain a more preferable herbal extract solution or to judge a preferable immersion completion time by measuring those terpenes and esters. For example, the composition of the present invention should preferably have a terpene concentration of 5 mg/L or higher, and more preferably 15 mg/L or higher. The ester concentration in the composition of the present invention is preferably 5 mg/L or higher, and more preferably 10 mg/L or higher.

The quantification of the above components can be performed by a known method. For example, components contained in the composition can be separated by liquid chromatography or gas chromatography, and quantified using a known detector.

The immersion liquid obtained by the above process may have the solid fraction removed by a known solid-liquid separation method as necessary. The solid-liquid separation method may be performed for example by filtration or centrifugation, and the unnecessary solids can be removed by methods such as microfilter penetration.

In addition, the herbal extract solution may be condensed by a known method in the present invention. For example, when the extract components, such as naringin or hesperidin, is lower than the above reference level, the extract solution may be condensed by methods including evaporation, decompression/distillation, or freeze-concentration. The above reference level can be used as the reference to determine the completion of condensation.

The herbal extract composition obtained by the present invention has not only a refreshing sweetness, but also a refreshing aroma extracted from herbs, so it may be used as a beverage by itself, and it is also quite preferable as additives for foods and drinks. For example, the composition of the present invention may be added to foods and drinks as a flavor, such as a sweetener or seasoning. Hence, the composition of the present invention can add a refreshing sweetness or aroma to foods and drinks.

### EXAMPLES

The present invention is explained below by Examples without being limited thereby. In addition, “%,” “part” and the like are based on weight and a numerical range includes the end points in the present specification unless stated otherwise.

### Example 1

Orange flowers (obtained from Cailleau Corporation, France) (5 g) were put in a glass cylinder, and 100 mL of ethanol solution was added before the cylinder was sealed, then the cylinder was kept still for 7 days at room temperature (23° C.). Eight types of ethanol solutions with different ethanol concentrations (v/v %) were used as immersion solvents to perform extraction. Ethanol solutions of different concentrations were obtained by diluting a 94% raw material ethanol to each concentration with distilled water. The obtained orange flower immersion liquid was filtered with a 0.45 μm microfilter, and an alcohol-based extract solution of orange flower petals was obtained as the filtrate.

Also, the amount of orange flower was altered to 20 g/L (Experiment No. 5) or 100 g/L (Experiment No. 6), and a 40% alcohol solution was used as the extraction solvent to obtain the extract solution by the above method.

This extract solution was measured concerning the contents of terpenes and esters using gas chromatography (Agilent Corporation, 6890) under the following conditions. Specifically, the total concentration of β-pinene, myrcene, limonene, Z-limonene oxide, E-limonene oxide, linalool, camphor, 1-terpinen-4-ol, citral [cis/trans] was quantified for terpenes, and the total concentration of acetal, furfural, phenylethanol, phenyl acetate, ethyl myristate, ethyl palmitate was quantified for esters.

<Measurement Condition for Gas Chromatography>
Column: Ultra2 [5% Phenyl Methyl A Siloxane, 50 m=0.32 mm I.D.×0.52 um film thickness] (Model No.; Agilent 19091B-115)
Oven: starting temperature of 40° C., raised up to 325° C.
Detector: FID Detector

In addition, the concentrations of naringin, hesperidin were measured by liquid chromatography (UHPLC produced by Agilent Co., Infinity 1290, Kinetex C18 Column, water-methanol gradient)

Three well-trained expert panelists performed a sensory evaluation concerning the obtained extract solution in a scale of four based on the following standard. ⊚: Feel a strong refreshing sweetness; ◯: Feel a refreshing sweetness; Δ: Feel slight sweetness; ×: Do not feel a pleasant sweetness.

In addition, a sensory evaluation of Sample 4 (the sample of Experiment No. 4) was performed, and the sweetness was compared with sucrose solutions of various concentrations.

The result of the sensory evaluation is shown in the table below with the measurement results for the different components. As seen from the table, the extract solution of orange flower petals obtained using a 50% alcohol solution exhibited efficient extraction of naringin and hesperidin, and it had a refreshing and pleasant sweetness. In addition, when the sweetness of Sample 4 was evaluated by comparison with the sucrose solution, the sweetness was equal to that of a 1.6% sucrose solution, which showed that this extraction solution is effective as a sweetener.

Also, the result concerning the amount of orange flowers was that an amount of 20 g/L made the aroma of an immersion liquid slightly weak (Experiment Nos. 4 to 6).

TABLE 1

| Experiment No | 1 | 2 | 3 | 4 | 5 | 6 | 7 | 8 | 9 | 10 |
|---|---|---|---|---|---|---|---|---|---|---|
| Extract alcohol conc.(%) | 10 | 20 | 30 | 40 | 40 | 40 | 50 | 60 | 70 | 90 |
| Petal amount (g/l) | 50 | 50 | 50 | 50 | 20 | 100 | 50 | 50 | 50 | 50 |
| Terpene(mg/l) | 3.3 | 4.4 | 7.6 | 18 | 10 | 33 | 23 | 55 | 47 | 40 |
| Ester (mg/l) | 20 | 17 | 5.5 | 16 | 9.0 | 18 | 27 | 18 | 18 | 9.7 |
| Naringin (mg/l) | 27 | 46 | 71 | 75 | 23 | 200 | 110 | 76 | 110 | 60 |
| Hesperidin (mg/l) | 24 | 150 | 370 | 410 | 240 | 910 | 490 | 440 | 500 | 230 |
| Sensory evaluation | X | X | ◯ | ⊚ | Δ | ⊚ | ⊚ | ◯ | ◯ | X |

### Example 2

The orange flower was added in an amount of 40 g/L against a 50% alcohol solution, then sucrose was added to that solution, after which the solution was subsequently left still in a sealed container for 1 to 3 weeks at room temperature to obtain an immersion liquid. An experiment was conducted to confirm the effect of saccharide concentration on the extract solution by adding sucrose at a level that imparts a brix value of 0 to 40 to a 50% alcohol solution (an extract solution having a brix value of 0 is sucrose free).

The obtained immersion liquid was subjected to a measurement of components and a sensory evaluation similar to Experiment Example 1. Sugar was removed from the immersion liquid using Extrelut™ NT1 produced by Merck Co. before evaluation.

The result is shown in the following table, and it can be read that the extraction was almost complete in one week. Also, the flavor of the obtained extract solution improved substantially when sucrose was added at a level that imparts a brix value of 20.

TABLE 2

| Experiment No | 1 | 2 | 3 | 4 | 5 | 6 | 7 | 8 |
|---|---|---|---|---|---|---|---|---|
| Brix | 0 | 5 | 10 | 20 | 30 | 30 | 30 | 40 |
| Immersion | 1 | 1 | 1 | 1 | 1 | 2 | 3 | 1 |
| period (wk) | | | | | | | | |
| Terpene(mg/l) | 19 | 17 | 21 | 22 | 24 | 22 | 24 | 29 |
| Ester (mg/l) | 14 | 15 | 18 | 19 | 15 | 57 | 58 | 13 |
| Naringin (mg/l) | 84 | 95 | 80 | 91 | 88 | 180 | 180 | 99 |
| Hesperidin | 260 | 280 | 260 | 280 | 260 | 680 | 790 | 250 |
| (mg/l) | | | | | | | | |
| Sensory | ◯ | ◯ | ◯ | ⊚ | ⊚ | ⊚ | ⊚ | ◯ |
| evaluation | | | | | | | | |

### Experiment Example 3

Various herbs were used for obtaining herbal extract solutions to confirm what effect each type of herb has. Petals of oranges (orange flower), buds of oranges (Cailleau Corporation, France), leaves of oranges (Cailleau Corporation, France), petals of jasmine (Cailleau Corporation, France), petals of elderflower (Cailleau Corporation, France), petals of acacia (Cailleau Corporation, France) were used as herbs, and they were added in an amount of 50 g/L against a 50% alcohol solution, and left still in a sealed container for four weeks at room temperature to obtain an immersion liquid.

The obtained immersion liquid was subjected to a measurement of components and a sensory evaluation similar to Experiment Example 1.

The result is shown in the following table, and it can be read that orange flowers showed the best sensory result, and the buds and leaves of oranges followed. Also concerning plants other than orange, a good result was observed for the extract solution of elderflower. The “n.d.” in the table indicates that the substance was not detected.

TABLE 3

| Experiment No | 1 | 2 | 3 | 4 | 5 | 6 |
|---|---|---|---|---|---|---|
| Orange/petals (g/l) | 50 | — | — | — | — | — |
| Orange/buds (g/l) | — | 50 | — | — | — | — |
| Orange/leaves (g/l) | — | — | 50 | — | — | — |
| Jasmine/petals (g/l) | — | — | — | 50 | — | — |
| Elderflower/petals(g/l) | — | — | — | — | 50 | — |
| Acacia/petals (g/l) | — | — | — | — | — | 50 |
| Terpene(mg/l) | 27 | 17 | 3.6 | 0.5 | 0.75 | 2.5 |
| Ester (mg/l) | 63 | 51 | 48 | 5.3 | 62 | 71 |
| Naringin (mg/l) | 88 | 1600 | 120 | 12 | 270 | 25 |
| Hesperidin (mg/l) | 430 | 520 | 490 | n.d. | 70 | n.d. |
| Sensory evaluation | ⊚ | ◯ | ◯ | X | Δ | X |

### Experiment Example 4

The effect on the flavor of the beverage when the herbal extract solution of the present invention is used as a sweetener or a seasoning was evaluated. Specifically, beverages were prepared by adding 5 mL of the extraction liquid of Sample 4 obtained in Experiment Example 1 to 1000 mL of each of the beverages below.
Near-water drink (Tennensui, Suntory Beverage & Food)
Tea drink (Jasmine tea, Suntory Beverage & Food)
Low calorie drink using sweeteners with high sweetness (Vitamin water, Suntory Beverage & Food)
Chu-hi (Calori Mediterranean Lemon, Suntory Liquors Limited)
Liqueur (Mistia, Suntory Liquors Limited)
Beers (Kinmugi, Suntory Liquors Limited)
Wine (Delica Maison White, Suntory Wine International Limited)
Spirits (Dry Gin, Suntory Liquors Limited)

Three expert panelists performed a sensory evaluation concerning the flavor of the prepared beverages in a scale of four based on the following standard. ⊚: Feel a strong refreshing sweetness; ◯: Feel a refreshing sweetness; Δ: Feel a slight sweetness; ×: Do not feel a pleasant sweetness.

The result is shown in the table below. By adding the liquid composition of the present invention, it was possible to impart flavor, particularly a refreshing sweetness, to all beverages.

TABLE 4

| | Evalu- | |
|---|---|---|
| Beverages | ation | Comments |
| Near-water | ⊚ | Feel strong refreshing sweetness, aroma |
| Tea beverage | ◯ | Feel refreshing sweetness |
| Low calorie | ◯ | Feel refreshing sweetness |
| beverage | | |
| Chu-hi | ◯ | Acidity is slightly masked, feel sweetness |
| Liqueur | ⊚ | Feel strong refreshing sweetness, aroma in |
| | | after taste |
| Beer | ◯ | Bitterness is slightly masked, feel refreshing |
| | | sweetness, aroma |
| Wine | ⊚ | Feel strong refreshing sweetness, aroma in |
| | | after taste |
| Spirits | ◯ | Feel refreshing sweetness |

1. A method for producing a liquid composition containing naringin at 60 mg/L or higher and hesperidin at 240 mg/L or higher, comprising
immersing herbs selected from petals, buds and leaves of a tree in an ethanol solution of 30 to 90 v/v % to obtain an immersion liquid containing naringin at 60 mg/L or higher and hesperidin at 240 mg/L or higher.

2. The method according to claim 1, wherein the herbs are petals of a citrus tree.

3. The method according to claim 1, wherein the herbs are petals of orange flower or elderflower.

4. The method according to claim 1, wherein immersion is performed by using an ethanol solution containing saccharides and having a brix value in a range of 5 to 40.

5. A liquid composition containing naringin at 60 mg/L or higher and hesperidin at 240 mg/L or higher, and obtained by immersing herbs selected from petals, buds and leaves of a tree in an ethanol solution.

6. The liquid composition according to claim 5 that is used to add sweetness.

7. A flavor containing the liquid composition according to claim 5.

8. A food and drink containing the liquid composition according to claim 5.

9. A method for adding sweetness to foods and drinks comprising adding the liquid composition according to claim 5.
